(19) United States
(12) Patent Application Publication
(10) Pub. No.: US 2007/0184222 A1
(43) Pub. Date: Aug. 9, 2007

(54) Hydrogel-supported porous semiconductor devices

(75) Inventors: Lisa Delouise, Rochester, NY (US); Benjamin L. Miller, Penfield, NY (US)

Correspondence Address: NIXON PEABODY LLP - PATENT GROUP, CLINTON SQUARE, P.O. BOX 31051, ROCHESTER, NY, 14603-1051, US

(73) Assignee: UNIVERSITY OF ROCHESTER, ROCHESTER, NY (US)

(21) Appl. No.: 11/578,930

(22) PCT Filed: Apr. 20, 2005
(86) PCT No.: PCT/US05/13526

§ 371 Date: Dec. 4, 2006

Related U.S. Application Data
(60) Provisional application No. 60/563,618, filed on Apr. 20, 2004.

(51) Int. Cl. B32B 27/32

(52) U.S. Cl. 428/35.2

(57) ABSTRACT

A product including a hydrogel matrix and a porous semiconductor material at least partially embedded within the hydrogel matrix. Also disclosed are methods of making the product and a substantially flexible porous semiconductor material, as well as methods of using the product to deliver a therapeutic agent to a subject and detecting the presence of a pathogen and/or infection at a wound site.

This application claims the benefit of U.S. Provisional Patent Application Ser. No. 60/563,618, filed Apr. 20, 2004, which is hereby incorporated by reference in its entirety.

### FIELD OF THE INVENTION

The present invention relates generally to hydrogel-supported porous semiconductor devices, their methods of manufacture, and their use in wound repair, drug delivery, and pathogen and infection detection at a wound site.

### BACKGROUND OF THE INVENTION

The current state of wound care product innovation centers around developing new materials that achieve key requirements of exudate adsorption, protection against infection, debridement, odor control, and maintaining hydration. Currently there is no noninvasive means to detect the presence of pathogenic organisms prior to the onset of infection, which is the leading impediment to wound healing followed by lack of blood flow to bilateral extremities. The challenge for the wound care professional is to be able to recognize the onset of the critical colonization condition that precedes infection and when inhibition of wound healing begins.

As the breadth of silicon chip-based biomedical diagnostic (biosensors) and therapeutic (drug delivery) technologies continues to expand, there exists a growing need to improve the biological/device interface for both in-vivo and ex-vivo applications. The biological/device interface sets operational constraints on the various mechanical, material, and preparatory aspects of how samples are collected, processed, and applied to a device as well as on establishing requirements for device biocompatibility, tolerance towards biofouling, and the stability of immobilized bioreagents. Typically, silicon chip-based devices (5-10 μm thick), including microfluidic MEMs devices, are fabricated from and remain attached to the rigid bulk silicon wafer support (˜0.5-0.6 mm thick). This architecture may limit device function, particularly for microfluidic porous structures for which optimum function may depend on the directionality of flow through the device. Improving the biological/device interface could significantly advance the performance characteristics and versatility of chip-based devices while enabling new applications. For example, wound care management could be revolutionized through the development of an optical biosensor device embedded in a flexible, therapeutic support matrix, which would improve the biological/device interface by enabling the device to be applied directly to a wound. It would also be desirable for such a device to provide conformal contact with a wound site, eliminating invasive sample collecting procedures; maintain activity of bioreagents for treatment of the wound site; and allow for direct optical readout of the sensor response (while contacting the wound) to signal the presence of pathogenic bacteria that may interfere in the healing process.

A solution to the outstanding need for real time molecular monitoring of bioburden in wound care management has yet to be realized. This challenge has not been met in part due to the inability to cost-effectively package a reliable and simple-to-use sensor chip technology into a flexible wound care product.

The present invention is directed to overcoming these and other deficiencies in the art.

### SUMMARY OF THE INVENTION

A first aspect of the present invention relates to a product that includes a hydrogel matrix and a porous semiconductor material at least partially embedded within the hydrogel matrix.

A second aspect of the present invention relates to a sterile package containing a sterile product according to the first aspect of the present invention.

A third aspect of the present invention relates to a method of making a substantially flexible porous semiconductor material. This method involves introducing a semiconductor substrate into an electrochemical etching bath, applying a current density for a sufficient duration to achieve a porous region of the semiconductor substrate, and second applying a sufficiently high current density to cause electropolishing of an interface between the porous region and a remainder of the semiconductor substrate, where the porous region is released from the remainder of the semiconductor substrate.

A fourth aspect of the present invention relates to a method of making a product that includes a hydrogel matrix and a porous semiconductor material at least partially embedded within the hydrogel matrix. This method involves providing a porous semiconductor material and at least partially embedding the porous semiconductor material in a hydrogel matrix.

A fifth aspect of the present invention relates to a method of detecting a pathogen and/or infection at a wound site. This method involves providing a product according to the first aspect of the present invention, where the porous semiconductor material includes a central layer interposed between upper and lower layers, each of the upper and lower layers including strata of alternating porosity. One or more probes, each of which is specific for one or more pathogens or one or more host markers of infection, are coupled to the porous semiconductor material, whereby a detectable change occurs in a refractive index of the porous semiconductor material upon binding of the probes to a target molecule. The product is applied to the wound site and a detectable change in the refractive index is observed upon binding of the target molecule, indicating presence of the pathogen and/or infection at the wound site.

A sixth aspect of the present invention relates to a method of delivering one or more therapeutic agents to a subject. This method involves providing a product according to the first aspect of the present invention with one or more therapeutic agents retained within one or more pores of the porous semiconductor material. The product is applied to a tissue of the subject, whereby the one or more therapeutic agents is delivered to the subject.

The present invention is an innovative technology that will advance wound care management to an unprecedented level. By accelerating the healing process and preventing significant or harmful infection through early detection, the present invention will assist health care professionals in achieving optimum patient outcomes while lowering treatment costs. The underlying sensor technology has already been demonstrated (see U.S. patent application Ser. No. 10/082,634 to Chan et al., which is hereby incorporated by reference in its entirety), and is extensible to a broad range of diagnostic modalities where portable biosensing is desired, such as in the home, work place, or battlefield.

### BRIEF DESCRIPTION OF THE DRAWINGS

FIG. 1 is a schematic diagram showing an embodiment of the product of the present invention.

FIGS. 2A-B are SEM images of an exemplary multilayer microcavity. FIG. 2A is a cross-sectional view. FIG. 2B is a top view, showing the porous surface.

FIG. 3 is a graph of the characteristic optical response of the multilayer microcavity depicted in FIGS. 2A-B. Reflection and photoluminescence are shown.

FIGS. 4A-B are graphs illustrating the optical response of the multilayer microcavity depicted in FIGS. 2A-B. FIG. 4A shows a shift in the characteristic optical response upon binding of glutaraldehyde to the multilayer microcavity after treatment with an aminosilane coupling agent. The optical response remained unchanged after exposure to glutaraldehyde when the microcavity was not pretreated with aminosilane (FIG. 4B).

FIG. 5 is an image of a porous semiconductor material (˜5.2 μm thick) embedded in a NU-GEL® Wound Dressing (Johnson & Johnson) polyvinyl pyrrolidone hydrogel matrix.

FIG. 6 is a graph of the reflectance spectra for the porous semiconductor material (˜5.2 μm thick) shown in FIG. 5, before and after mounting it in a NU-GEL® Wound Dressing hydrogel sheet. Data illustrate the long-term stability of the device optical response in the hydrogel, which undergoes ˜150 nm red shift after transfer to the gel. This shift is consistent with filling the pores 100% with a substance exhibiting an index of refraction nearly equal to water.

FIGS. 7A-B are graphs illustrating the optical response from a porous semiconductor material (˜3.7 μm thick) supported in a NU-GEL® Wound Dressing sheet following repeated exposures to water (7A) and increasing % sucrose solutions (7B). A concentration-dependent shift in the optical response is demonstrated (7B).

FIGS. 8A-B are graphs illustrating the RIU sensitivity of the porous semiconductor material (˜3.7 microns) whose optical response is shown in FIGS. 7A-B. FIG. 8A shows the response to sucrose of the optical porous semiconductor material after being supported in a NU-GEL® Wound Dressing sheet. The resonance frequency was ˜627 nm when the pores were filled with air following 24 hour exposure to ethanolic 30% H₂O₂ to create hydrophilic pore channels. Embedding in the gel caused +119 nm red shift and a wavelength shift RIU sensitivity of ˜190 nm/RIU. A ConMed gel-supported porous semiconductor material yielded a similar RIU sensitivity of ˜176 nm/RIU. FIG. 8B shows the response to sucrose of an experimental control (the optical microcavity supported in a silicon wafer (i.e., prior to electropolishing)). The frequency was ˜703 nm when the pores were filled with air following 2 hour exposure to ethanolic 30% H₂O₂ to create hydrophilic pore channels. Filling the pores 100% with water produced a ˜145 nm red shift. Exposure to sucrose solutions yielded a wavelength shift RIU sensitivity of ˜454 nm/RIU.

### DETAILED DESCRIPTION OF THE INVENTION

The present invention relates to products that include a hydrogel matrix and a porous semiconductor material at least partially embedded or fully embedded (i.e., encapsulated) within the hydrogel matrix.

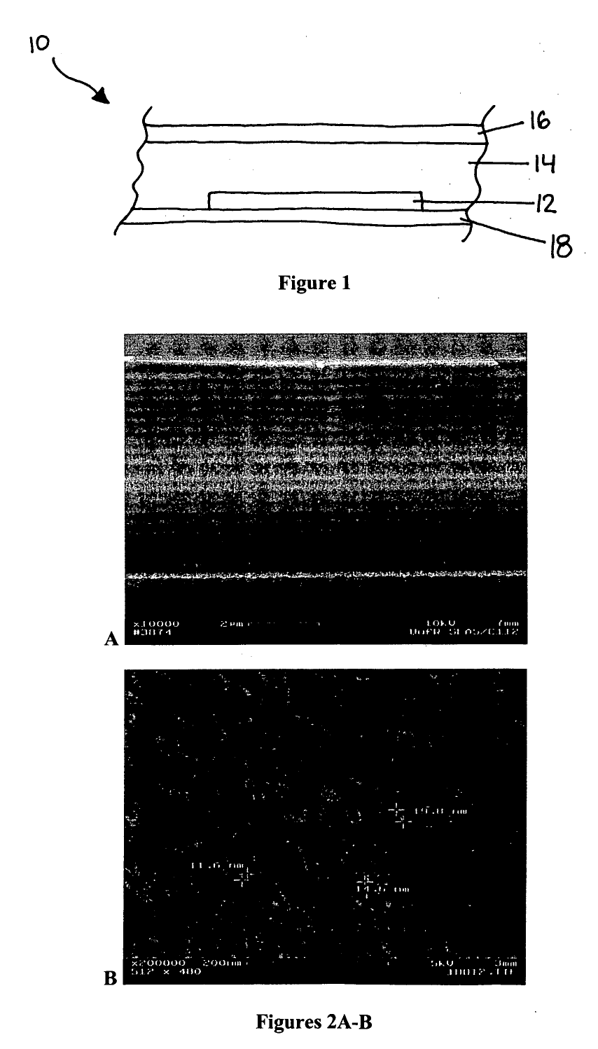

According to one embodiment shown in FIG. 1, the product 10 includes a porous semiconductor material 12 embedded within a hydrogel matrix 14. Attached to one side of the matrix is an optional vapor barrier 16. Attached to the opposite side of the matrix is an optional release layer 18.

A hydrogel support matrix was selected because of the growing importance hydrogels have in state-of-the-art wound care technology, tissue engineering, and drug delivery (Peppas et al., “Physicochemical Foundations and Structural Design of Hydrogels in Medicine and Biology, Biomed. Engin. 2:9-29 (2000); Senet, Ann. Dermatol. Venereol. 131(4):351 (2004); Kirker et al., J Burn Care Rehabil. 25(3):276 (2004), which are hereby incorporated by reference in their entirety). Additionally, the properties of the hydrogel material can be tailored to maintain critical environmental conditions (e.g., hydration, pH, and ionic strength) vital to sustaining activity of immobilized biomolecules while enabling binding and recognition to occur in a more “solution-like” environment. The absorptive properties of polymeric hydrogels can also be tailored to confer an active function in managing fluidics, for example to direct exudate from a wound to flow through the porous semiconductor material. As such, hydrogels are being increasingly investigated as a preferred substrate for proteomic biosensor chips and microarray applications (Zhang, “Wet or Let Die,” Nature Materials 3:7-8 (2004); Kiyonaka et al., “Semi-wet Peptide/Protein Array Using Supramolecular Hydrogel,” Nature Materials 3:58-64 (2004); Charles et al., “Fabrication and Characterization of 3D Hydrogel Microarrays to Measure Antigenicity and Antibody Functionality for Biosensor Applications,” Biosensors and Bioelectronics, 20(4):753-764 (2004), each of which is hereby incorporated by reference in its entirety).

Any hydrogel suitable for use in wound care can be utilized in the products of the present invention, including synthetic hydrogels, natural hydrogels, and mixtures thereof. Exemplary hydrogels include, without limitation, those found in commercial or investigative wound care products available from Johnson & Johnson (e.g., NU-GEL® Wound Dressing, NU-GEL® Collagen Wound Gel), Coloplast, 3M (e.g. 3M™ Tegaderm™ Absorbent Clear Acrylic Dressing), and prototype composites currently under investigation supplied by ConMed (e.g., ClearSite® TM Transparent Membrane), as well as polyacrylamide hydrogels, polyvinyl pyrrolidone hydrogels, polylactic acid (PLA) hydrogels, polyglycolic acid (PGA) hydrogels, polyethylene glycol (PEG) hydrogels, agarose hydrogels, collagen hydrogels, acrylic hydrogels, and those disclosed in Peppas et al., “Physicochemical Foundations and Structural Design of Hydrogels in Medicine and Biology, Biomed. Engin. 2:9-29 (2000); U.S. Pat. No. 6,855,743 to Gvozdic (polyvinyl alcohol hydrogels), U.S. Pat. No. 6,800,278 to Perrault et al. (e.g., acrylated quaternary ammonium monomeric hydrogels), U.S. Pat. No. 6,861,067 to McGhee et al. (polyurethane hydrogels), U.S. Pat. No. 6,710,104 to Haraguchi (organic/inorganic hybrid hydrogels), U.S. Pat. No. 6,468,383 to Kundel (e.g., hydrogel laminates formed by crosslinking of one or more hydrophilic polymers), U.S. Pat. No. 6,238,691 to Huang (polyurethane hydrogels with, optionally, antimicrobial and/or bacteriostatic agents), and U.S. Pat. No. 5,932,552 to Blanchard et al. (hydrogels formed of cross-linked keratin), each of which is hereby incorporated by reference in its entirety. As will be apparent to one of skill in the art, the hydrogels may also include additional agents useful for the application of choice including, for example, antimicrobial agents, bacteriostatic agents, antiviral agents, and antifungal agents.

The porous semiconductor material can be of any suitable design or construction. Exemplary constructions include simple porous structures of the type disclosed in U.S. Pat. No. 6,248,539 to Ghadiri et al., which is hereby incorporated by reference in its entirety, as well as microcavity structures of the type disclosed in Vinegoni et al., “Porous Silicon Microcavities,” in Nalwa, ed., Silicon Based Materials and Devices, Properties and Devices, Vol. 2, Academic Press, pp. 124-188 (2001); U.S. Patent Application Ser. No. 60/661,674 to Ouyang et al.; U.S. patent application Ser. No. 10/082,634 to Chan et al.; and DeLouise & Miller, Proc. SPIE, 5357:111 (2004), each of which is hereby incorporated by reference in its entirety. Preferably, the semiconductor material has been removed from its underlying solid substrate prior to embedding in the matrix. As a consequence, the preferred porous semiconductor materials are substantially flexible, meaning they are flexible enough for the product to be applied to a non-planar surface.

The porous semiconductor material can be any suitable thickness depending upon the intended use, but preferably less than about 25 microns, more preferably between about 2 to about 15 microns. Typically, the thickness will vary inversely according to the desired porosity (i.e., higher porosity structures will be thicker than lower porosity structures) as well as according to the wavelength of light to be detected (i.e., structures which are used with shorter wavelength light can be thinner than structures which are used with longer wavelength light).

The pores (or cavities) in the porous semiconductor material are typically sized in terms of their nominal “diameter” notwithstanding the fact that they are somewhat irregular in shape and vary in diameter from one strata to another. These diameters range from about 2 nm to about 2000 nm, with diameters of about 10 to about 100 nm being preferred for visible light, about 2 to about 50 nm diameters being preferred for ultraviolet light, and 100 to 2000 nm being preferred for infrared light. The nominal pore diameter should also be selected based upon the size of the target molecule(s) to be detected and/or the therapeutic agent(s) to be retained therein.

The porous semiconductor materials can be fabricated according to any known procedures, e.g., those disclosed in Vinegoni et al., “Porous Silicon Microcavities,” in Nalwa, ed., Silicon Based Materials and Devices, Properties and Devices, Vol. 2, Academic Press, pp. 124-188 (2001); U.S. Patent Application Ser. No. 60/661,674 to Ouyang et al.; U.S. patent application Ser. No. 10/082,634 to Chan et al.; DeLouise & Miller, Proc. SPIE, 5357:111 (2004); and U.S. Provisional Patent Application to DeLouise, “Methods of Making and Modifying Porous Devices for Biosensor Applications,” filed Apr. 20, 2005, each of which is hereby incorporated by reference in its entirety. Basically, single layer devices can be fabricated by applying a constant current for a fixed period of time to achieve a substantially uniform porosity. Multilayer devices can be fabricated by cycling between different current densities for desired time periods to produce different porosity layers. The electrochemical fabrication process can be controlled to produce a wide range of pore diameters and pore channel morphologies (dendritic—highly anisotropic).

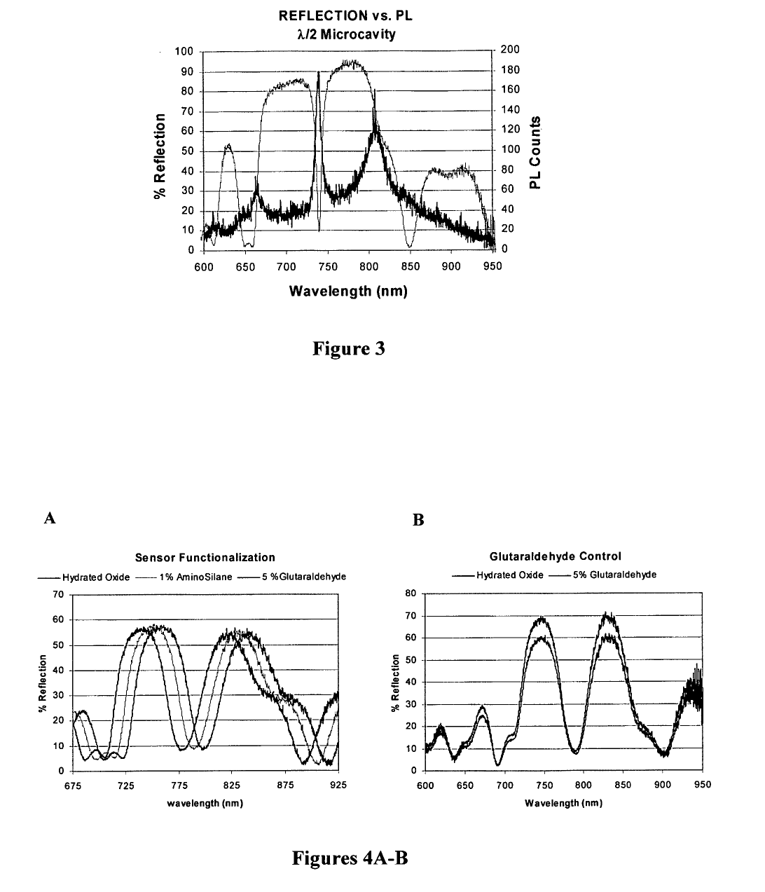

Single and multilayer porous semiconductor structures are useful for substance delivery, and multilayer devices are particularly useful for optical sensing applications. The optical properties of the layer(s) may be designed for regulating the time release characteristics of the porous semiconductor material. A typical multilayer microcavity device supported in a single crystal wafer is shown in FIGS. 2A (cross section) and 2B (top view). It has a characteristic optical response, both in reflection and photoluminescence, as shown in FIG. 3. In addition to defining the optical properties of the microcavity device, the multilayer microstructure can serve as a scaffold to which biomolecular probes may be covalently immobilized. A biomolecular binding event changes the microstructure's porosity, causing a shift in the characteristic optical response of the microcavity relative to a control, as shown in FIG. 4. Similar shifts will occur upon binding of probes to target molecules, as discussed hereinafter and as reported in U.S. patent application Ser. No. 10/082,634 to Chan et al., which is hereby incorporated by reference in its entirety.

Semiconductor substrates which can be used to form the porous semiconductor material according to the present invention can be composed of a single semiconductor material, a combination of semiconductor materials which are unmixed, or a mixture of semiconductor materials.

Preferred semiconductor substrates which can be used to form the porous semiconductor material according to the present invention include, without limitation, silicon and silicon alloys. The semiconductor substrate is amenable to galvanic etching processes, which can be used to form the porous semiconductor material. These semiconductor materials can include, for example, p-doped (e.g., (CH₃)₂Zn, (C₂H₅)₂Zn, (C₂H₅)₂Be, (CH₃)₂Cd, (C₂H₅)₂Mg, B, Al, Ga, In) silicon, n-doped (e.g., H₂Se, H₂S, CH₃Sn, (C₂H₅)₃S, SiH₄, Si₂H₆, P, As, Sb) silicon, intrinsic or undoped silicon, alloys of these materials with, for example, germanium in amounts of up to about 10% by weight, mixtures of these materials, semiconductor materials based on Group III element nitrides (e.g., AlN, GaN, InN), and semiconductor materials based on Group III.V materials (e.g., InₓGa₁₋ₓAs, AlₓGa₁₋ₓAs, GaAs, InP, InAs, InSb, GaP, GaSb).

In at least one embodiment, the porous semiconductor material is a multilayer structure that includes a central layer interposed between upper and lower layers and, optionally, one or more probes coupled to the porous semiconductor material. The upper and lower layers individually contain strata of alternating porosity, i.e., higher and lower porosity strata, relative to the adjacent strata. The upper layer and lower layer can be symmetrical (i.e., having the same configuration, including the number of strata) or they can be different (i.e., having different strata configurations in number and/or porosity). Typically, the total number of strata is six or more (i.e., three or more high porosity strata and three or more low porosity strata in an alternating configuration).

The lower porosity strata simply have a porosity which is less than the porosity of their adjacent higher porosity strata. Within each of the upper and lower layers on opposite sides of the central layer, the low porosity and high porosity strata need not be the same throughout. Thus, different low porosity strata and different high porosity strata can be present within a single upper or lower layer. Alternatively, the low porosity strata and the high porosity strata will be substantially consistent within the upper and lower layers.

The products of the present invention may be designed as sensor devices and/or therapeutic agent delivery devices embedded within a hydrogel matrix, whereby the sensor or therapeutic agent delivery device maintains functional properties despite being embedded within the matrix. In other words, the sensor can detect binding of target molecules, and the delivery device can effectively deliver drugs or other therapeutic agents through the hydrogel matrix. Products designed to function as both a sensor and therapeutic agent delivery device are also contemplated, including, for example, applications in which the optical response of the porous semiconductor material is used to monitor the time released delivery of therapeutic agent(s).

Biological substances of various sizes can be immobilized within the porous semiconductor material to achieve these functions. For example, the porous semiconductor material can be designed to function as an interferometric label-free biosensor capable of detecting pathogenic organisms, host markers of infection, and other important proteomic and genomic health markers. Under certain conditions, indirect spectrophotometric detection techniques using enzymatic or fluorophor constructs may be viable alternatives to report the target-binding event (DeLouise & Miller, “Quantitative Assessment of Enzyme Immobilization Capacity in Porous Silicon,” Anal. Chem. 76(23):6915-6920 (2004); DeLouise & Miller, “Enzyme Immobilization in Porous Silicon Biochip—Quantitative Analysis of the Kinetic Parameters for Glutathione-S-Transferases,” Anal. Chem. 77(7)1950-1956 (2005); DeLouise & Miller, “Cross-Correlation of Optical Microcavity Biosensor Response With Immobilized Enzyme Activity—Insights in Structural Biology,” Anal. Chem. online, reference DOI 10.1021/ac048144+(2005), each of which is hereby incorporated by reference in its entirety).

As another example, the porous semiconductor material may include one or more probes coupled to it. Suitable techniques for coupling probes to porous semiconductor materials include, for example, those disclosed in U.S. patent application Ser. No. 10/082,634 to Chan et al., and U.S. Patent Application Ser. No. 60/661,674 to Ouyang et al., each of which is hereby incorporated by reference in its entirety. In this and all aspects of the present invention involving probes, the probes are able to bind to a target molecule, whereby a detectable change occurs in a refractive index of the porous semiconductor material upon binding of the probes to the target molecule.

Suitable probe coupling agents include, for example, silanes (e.g., 3-glycidoxypropyltrialkoxysilanes with C1-6 alkoxy groups, trialkoxy(oxiranylalkyl)silanes with C2-12 alkyl groups and C1-6 alkoxy groups, 2-(1,2-epoxycyclohexyl)ethyltrialkoxysilane with C1-6 alkoxy groups, 3-butenyl trialkoxysilanes with C1-6 alkoxy groups, alkenyltrialkoxysilanes with C2-12 alkenyl groups and C1-6 alkoxy groups, tris[(1-methylethenyl)oxy]3-oxiranylalkyl silanes with C2-12 alkyl groups, [5-(3,3-dimethyloxiranyl)-3-methyl-2-pentenyl]trialkoxysilane with C1-6 alkoxy groups, (2,3-oxiranediyldi-2,1-ethanediyl)bis-triethoxysilane, trialkoxy[2-(3-methyloxiranyl)alkyl]silane with C1-6 alkoxy groups and C2-12 alkyl groups, trimethoxy[2-[3-(17,17,17-trifluoroheptadecyl)oxiranyl]ethyl]silane, tributoxy[3-[3-(chloromethyl)oxiranyl]-2-methylpropyl]silane, and combinations thereof).

Suitable probes include, for example, non-polymeric small molecules, polypeptides or proteins, antibodies, oligonucleotides, and combinations thereof. As will be apparent to one of skill in the art, the probes can be the same or different, and may target the same or different target molecules. In at least one aspect of the present invention the probes are specific for one or more pathogens and/or one or more host markers of infection.

Detecting target molecules to indicate the presence of pathogens is described in, for example, U.S. Pat. No. 6,562,782 to Miller et al., U.S. patent application Ser. No. 10/772,599 to Kende et al., and U.S. patent application Ser. No. 10/082,635 to Chan et al., each of which is hereby incorporated by reference in its entirety. Suitable target molecules include, for example, peptidoglycan (indicates presence of gram negative bacteria), lipopolysaccaride endotoxin (indicates presence of gram positive bacteria), cholera toxin, pertussis toxin, B. anthracis lethal factor, Staphylococcus aureus a-toxin, and TIR receptor (indicates presence of enteropahogenic E. coli).

Detecting host markers to indicate presence of infection is described in, for example, Ng, “Diagnostic markers of infection in neonates,” Arch. Dis. Childhood Fetal and Neonatal Ed. 89(3):F229-235 (2004), which is hereby incorporated by reference in its entirety. Suitable host markers of infection include, for example, granulocyte colony-stimulating factor (G-CSF); fibrinogen; thrombin-antithrombin III complex (TAT); plasminogen activator inhibitor-1 (PAI-1); plasminogen tissue activator (tPA); acute phase proteins and other proteins, e.g., α-1 antitrypsin, C reactive protein (CRP), fibronectin, haptoglobin, lactoferrin, neopterin, orosomucoid, procalcitonin (PCT); components of the complement system (e.g., C3a-desArg, C3bBbP, sC5b-9); chemokines, cytokines and adhesion molecules (e.g., interleukin (IL)1β, IL1ra, IL2, sIL2R, IL4, IL5, IL6, IL8, and IL10; tumour necrosis factor (TNF), 11sTNFR-p55, and 12sTNFR-p75; interferon (IFN); E-selectin; L-selectin; soluble intracellular adhesion molecule-1 (sICAM-1); vascular cell; adhesion molecule-1 (VCAM-1)); and cell surface markers for, for example, neutrophils (e.g., CD11b, CD11c, CD13, CD15, CD33, CD64, CD66b), lymphocytes (e.g., CD3, CD19, CD25, CD26, CD45RO, CD69, CD71), and monocytes (e.g., HLA-DR).

Alternatively or additionally, the porous semiconductor material can serve as a reservoir to house therapeutic agents. In this aspect of the present invention, the porous semiconductor material includes one or more therapeutic agents retained within one or more pores of the semiconductor material. By tailoring the biodegradability of the porous semiconductor material, the therapeutic agents may be delivered to tissues in vivo. Alternatively, the therapeutic agents may be retained within the pore(s) in a manner in which their delivery is not dependent upon biodegradation of the porous semiconductor material, but instead upon their diffusion from the porous semiconductor material and through the matrix. Suitable therapeutic agents according to this and all aspects of the present invention include, without limitation, growth factors, keratins, cytokines, antibiotic agents, antifungal agents, antiviral agents, and tumor suppressor agents.

The wound healing process involves a complex series of biological interactions at the cellular level which can be grouped into three phases: hemostasis and inflammation; granulation tissue formation and reepithelization; and remodeling (Clark, “Cutaneous Tissue Repair: Basic Biological Considerations,” J. Am. Acad. Dermatol. 13:701-725 (1985), which is hereby incorporated by reference in its entirety). Keratinocytes (epidermal cells that manufacture and contain keratin) migrate from wound edges to cover the wound.

Growth factors such as transforming growth factor-β(TGF-β) play a critical role in stimulating the migration process. The migration occurs optimally under the cover of a moist layer. Polypeptide growth factors regulate the growth and proliferation of cells. A number of human growth factors have been identified and characterized. Merely by way of example, these include basic fibroblast growth factor (bFGF), acidic fibroblast growth factor (aFGF), vascular endothelial cell growth factor (VEGF), platelet derived growth factor (PDGF), insulin-like growth factors (IGF-I and IGF-II), nerve growth factor (NGF), epidermal growth factor (EGF) and heparin-binding EGF-like growth factor (HBEGF). Because of their ability to stimulate cell growth and proliferation, growth factors have been used as wound healing agents. Some growth factors, such as bFGF and VEGF exhibit potent angiogenic effects, i.e. they stimulate the growth of new capillary vessels. These angiogenic growth factors have been used to treat conditions associated with ischemia, such as coronary artery disease and peripheral vascular disease. By treating ischemic tissue with an angiogenic growth factor, new blood vessels are generated which are capable of bypassing occluded segments of arteries, thereby reestablishing blood flow to the affected tissue (a procedure sometimes referred to as a “bio-bypass”). Angiogenic growth factors have also been used to promote wound healing. Transforming growth factor (TGF) stimulates keratinocytes.

Keratins have been found to be necessary for reepithelization. Specifically, keratin types K5 and K14 have been found in the lower, generating, epidermal cells, and types K1 and K10 have been found in the upper, differentiated cells (Cohen et al, eds., Wound Healing: Biochemical and Clinical Aspects, W. W. Saunders Company (1992), which is hereby incorporated by reference in its entirety). Keratin types K6 and K10 are believed to be present in healing wounds, but not in normal skin. Keratins are major structural proteins of all epithelial cell types and appear to play a major role in wound healing.

Cytokines have been shown to promote proliferation of fibroblasts and collagen production (IL-1β and IL-1RA), promote angiogenesis (TNF-α), and encourage T-cell maturation, macrophage maturation, and INF-γ production (IL-12).

As will be apparent to one of skill in the art, suitable products according to the present invention may include those with a single porous semiconductor material, or an array of porous semiconductor materials, customized with probes and/or therapeutic agents suitable for a specific application.

Any suitable vapor barrier can be used on the product of the present invention. Exemplary vapor barriers include, without limitation, any known backing material having a low vapor transmission rate, for example, polyurethane and ethylene vinyl acetate. In aspects of the present invention relating to sensor applications, the vapor barrier is, preferably, optically clear to allow detection, through the vapor barrier, of the optical response of the porous semiconductor material.

Any suitable release layer can be used on the product of the present invention. The release layer should be selected to allow for simple removal from the hydrogel surface. Exemplary release layers include, without limitation, polymeric films (e.g., polyethylene, polyester, PVC, polypropylene, or cellulose acetate), and siliconised plastic and paper.

The product, once formed, is intended to be used at a wound site. Thus, the fabrication procedures are intended to be conducted in a sterile environment. Moreover, the sterile product, once prepared, is intended to be packaged in a sterile packaging to allow for distribution and handling prior to end use. Sterile packaging procedures are known in the art.

The present invention also relates to a method of making a substantially flexible porous semiconductor material that can be used in the products of the present invention. This method involves introducing a semiconductor substrate into an electrochemical etching bath and applying a current density for a sufficient duration to achieve a porous semiconductor region of the semiconductor substrate. A sufficiently high current density is then applied (after forming the porous region) to cause electropolishing of an interface between the porous semiconductor region and a remainder of the semiconductor substrate. In this manner, the porous semiconductor region is released from the remainder of the semiconductor substrate.

The parameters of the first electrochemical etching step (producing the porous semiconductor region) may be designed by one of skill in the art depending upon the type of substrate used and the desired properties of the porous semiconductor material. Suitable procedures include those described above.

The second electrochemical etching step (releasing the porous semiconductor material) is carried out by applying a sufficiently high current density to electropolish the porous semiconductor region from the substrate. The specific current density and etch time, as will be apparent to one of skill in the art, depends on the etching conditions (e.g., composition of the etchant solution, composition of the semiconductor material, etc.). An exemplary current density for p+ silicon (0.01 ohm-cm) is at least about 200 mA/cm² for 2-3 seconds using a 14% HF-ethanol electrolyte.

An additional step may be carried out to create one or more hydrophilic pore channels in the porous semiconductor material. This step may be carried out either prior to or following release of the porous semiconductor material from the substrate.

Hydrophilic pore channels may be created by, for example, wet or dry thermal oxidation, treatment with hydrogen peroxide (e.g., immersing the released porous semiconductor material in a solution comprising ethanol and hydrogen peroxide), and treatment with ozone. On addition to creating hydrophilic pore channels, oxidation also stabilizes the porous semiconductor material against corrosion by biological fluids (Canham et al., “Derivatized Porous Silicon Mirrors: Implantable Optical Components with Slow Resorbability,” Physica Status Solidi (a) 182, 521 (2000); Anderson et al., “Dissolution of Different Forms of Partially Porous Silicon Wafers Under Simulated Physiological Conditions,” Physica Status Solidi (a) 197(2):331-335 (2003), each of which is hereby incorporated by reference in its entirety).

Another aspect of the present invention is a method of making a hydrogel matrix and a porous semiconductor material at least partially embedded within the hydrogel matrix. This method involves preparing a porous semiconductor material (i.e., as described above) and at least partially embedding the porous semiconductor material in a hydrogel matrix.

Any modification of the porous semiconductor material, including coupling of probes, loading of therapeutic agents, etc., is preferably performed prior to at least partially embedding the porous semiconductor material into the hydrogel matrix.

In at least one embodiment, the porous semiconductor material is laminated onto an existing hydrogel matrix. In another embodiment, an activated hydrogel precursor (i.e., monomer) solution is poured over the porous semiconductor material. The solution is then subjected to one or more cross-linking steps under conditions effective to produce a hydrogel matrix. The cross-linking can be carried out using known procedures and can include the use of polymerization initiators (e.g., thermal, chemical, or photo initiators).

Yet another aspect of the present invention is a method of detecting a pathogen and/or infection at a wound site. This method involves providing a product according to the present invention in which the porous semiconductor material contains one or more probes for a target molecule (of the pathogen or host marker of infection to be detected), where the optical properties of the semiconductor material will shift following binding of the target molecule to indicate presence of the pathogen and/or infection. According to a preferred embodiment, the porous semiconductor material is in the form of a microcavity sensor that includes a central layer interposed between upper and lower layers, each of the upper and lower layers including strata of alternating porosity. One or more probes, each of which is specific for one or more pathogens (i.e., target molecules that identify the pathogen) or infection (i.e., target molecules that are host markers of infection), are coupled to the porous semiconductor material, whereby a detectable change occurs in a refractive index of the porous semiconductor material upon binding of the probes to the target molecules. The product is applied to the wound site and a detectable change in the refractive index is observed following probe binding to the target molecule. Different target molecule binding events can be distinguished based on, e.g., location of the signal on an arrayed semiconductor material or the size of the refractive index shift, with different target molecules producing different shifts in the indices.

The hydrogel matrix can be chosen, for example, to enable detection from the back side of the porous semiconductor material, meaning the sensor can be read with a hand-held device while the product remains applied to the patient. The physical components of the detector have been described elsewhere (U.S. Pat. No. 6,248,539 to Ghadiri et al.; and U.S. patent application Ser. No. 10/082,634 to Chan et al., each of which is hereby incorporated by reference in its entirety). This is a benefit in wound treatment because it is often desirable to avoid removal of bandages to test for infection. Premature removal of bandages can damage the healing tissues at the wound site and/or allow for introduction of pathogens to the wound site, both of which should be avoided.

Still another aspect of the present invention is a method of delivering one or more therapeutic agents to a subject. This method involves providing a product according to the present invention, for example, a product in which one or more therapeutic agents are retained within one or more pores of the porous semiconductor material. The product is applied to a tissue of the subject whereby the one or more therapeutic agents is delivered to the subject. In at least one embodiment, the porous semiconductor material can be designed to biodegrade at a desired rate when applied to the tissue. In this aspect of the present invention, the therapeutic agent(s) retained within the porous semiconductor material are released as the porous semiconductor material biodegrades. In another embodiment, the porous semiconductor material is bioinert, and the therapeutic agent(s) is retained within the porous semiconductor material in a manner in which the therapeutic agent diffuses from the porous semiconductor material and through the matrix. In all aspects of the present invention, a change in optical response of the porous semiconductor material indicates that the therapeutic agent(s) are being released from the porous semiconductor material.

### EXAMPLES

The following examples are intended to illustrate, but by no means are intended to limit, the scope of the present invention as set forth in the appended claims.

### Example 1—Fabrication of Porous Semiconductor Material

Details of exemplary mesoporous silicon λ/2 microcavity fabrication methods are described in, e.g., Vinegoni et al., in Nalwa, ed., Silicon Based Materials and Devices: Properties and Devices, Vol. 2, Academic Press, pg. 124 (2001), and DeLouise & Miller, Proc. SPIE, 5357:111 (2004), each of which is hereby incorporated by reference in its entirety. Briefly, a multilayer microcavity was fabricated by anodic electrochemical etching of a p⁺ silicon <100> wafer using an ethanolic 14% HF electrolyte. A constant current density was applied for a fixed time and cycled between different current densities to produce a multilayer device with different porosity layers. A current density of 20 mA/cm² at an etch rate of ˜18 nm/sec produces a low porosity layer of ˜65%. A current density of 70 mA/cm² at an etch rate of ˜37 nm/sec produces a higher porosity layer of ˜85%. Each mirror used in this Example contains 9 periods of high and low porosity layers. Porosity is related to index of refraction through effective medium theory.

A high current density that exceeds the electropolishing limit (>200 mA/cm²) was then applied to the multilayer microcavity for 1-3 seconds to release the microcavity from the silicon wafer, yielding a substantially flexible, porous semiconductor material. Following release, hydrophilic pore channels were created in the porous semiconductor material by thermal oxidation at 900° C., or by immersion in a 30% H₂O₂ solution containing ethanol at room temperature. Oxidation also helps to protect the porous semiconductor material from biochemical degradation that could result from exposure to aggressive additives (e.g., cross-linking agents, amines) or from contact with solutions of extremely high (>8) or low (<5) pH (Canham et al., Advanced Materials, 111:1505 (1999), which is hereby incorporated by reference in its entirety), and improves the semiconductor material's biocompatibility (Canham et al., “Derivatized Porous Silicon Mirrors: Implantable Optical Components with Slow Resorbability,” Physica Status Solidi (a) 182, 521 (2000); Anderson et al., “Dissolution of Different Forms of Partially Porous Silicon Wafers Under Simulated Physiological Conditions,” Physica Status Solidi (a) 197(2):331-335 (2003), each of which is hereby incorporated by reference in its entirety). Depending on the oxidation conditions, as will be apparent to one of skill in the art, oxidation may also create a protective coating on the porous semiconductor material.

A blue shift in the microcavity optical response indicates oxidation has occurred. It was previously reported that the magnitude of the blue shift following thermal oxidation is porosity dependent, typically ranging between 60-100 nm (DeLouise & Miller., Proc. SPIE, 5357:111 (2004), which is hereby incorporated by reference in its entirety). Exposure to 30% H₂O₂ for 2 hours yields a ˜30 nm blue shift. No additional blue shift results following longer exposures of up to 24 hours.

### Example 2—Forming Hydrogel-Supported Porous Semiconductor Material

Hydrogel-supported porous semiconductor material sensors were prepared by either laminating the released porous semiconductor material directly onto pre-cross-linked gel or by pouring an activated solution of monomer over the microcavity prior to the onset of cross-linking. Synthetic (polyacrylamide, polyvinyl pyrrolidone) and natural (agarose) hydrogels and their mixtures were used.

Alternatively, the released porous semiconductor material was laminated onto pre-cross-linked commercially available wound care products, for example NU-GEL® Wound Dressing sheet (Johnson and Johnson) (“NU-GEL® sheet”), NU-GEL® Collagen Wound Gel (Johnson and Johnson) (“NU-GEL®Gel”), 3M™ Tegaderm™ Absorbent Clear Acrylic Dressing (3M), and ClearSite® TM Transparent Membrane sheet (ConMed). Commercial bandages offer a unique advantage in that they are typically packaged in a semi-dehydrated state and they are engineered with tack on the gel-matrix side to enable good adherence to skin. Tack facilitates lift-off of the porous semiconductor material from the underlying silicon wafer by contact lamination. However, commercial sheets are also typically coated on the back side with a thin, sometimes fibrous layer to prevent dehydration while imparting sturdiness for handling. The backing layer can interfere with optical measurements.

Depending upon the swelling characteristics of the gel utilized, an inhomogeneous expansion may result. This can cause a time-dependent instability and, in some cases, an irreversible degradation in the optical properties of the embedded porous semiconductor material. Therefore, gels should be selected with swelling characteristics that minimize inhomogeneous expansion.

### Example 3—Testing of Optical Response, Stability, and Sensitivity of the Hydrogel-Supported Porous Semiconductor Material

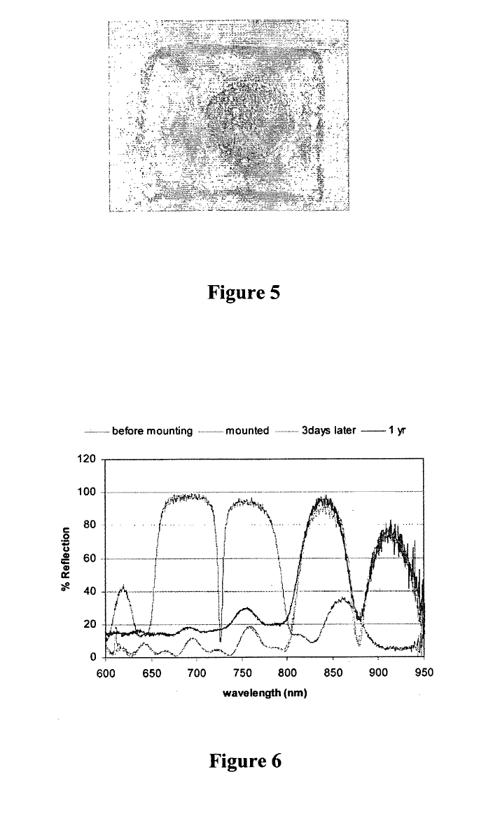

A porous semiconductor material (˜5.2 μm thick) was constructed from p+ silicon with 9 periods per mirror of a high porosity (85%) and low porosity (˜65%), tuned to operate in the visible spectrum with a resonance dip at 725 nm, and transferred by contact lamination to a NU-GEL® sheet, shown in FIG. 5.

The optical response before transfer, immediately after transfer, 3 days after transfer, and 1 year following transfer is shown in FIG. 6. The porous semiconductor material resonance undergoes a large red wavelength shift of ˜150 nm resulting from transfer to the hydrogel. The magnitude of the red shift is consistent with optical simulations in which air in the pores is displaced 100% with water (η=1.33) (see DeLouise & Miller., Proc. SPIE, 5357:111 (2004), which is hereby incorporated by reference in its entirety). FIG. 6 also demonstrates how remarkably stable the sensor membrane mounted in the gel is. The optical response remains essentially unchanged even after one year, withstanding numerous cycles of desiccation and rehydration. The long-term stability of the gel-supported sensor depends, however, on the fabrication conditions for both the porous silicon and the gel. For example, a hydride-terminated membrane exposed to an activated monomer solution of polyacrylamide at high pH (>8) will readily degrade the porous silicon.

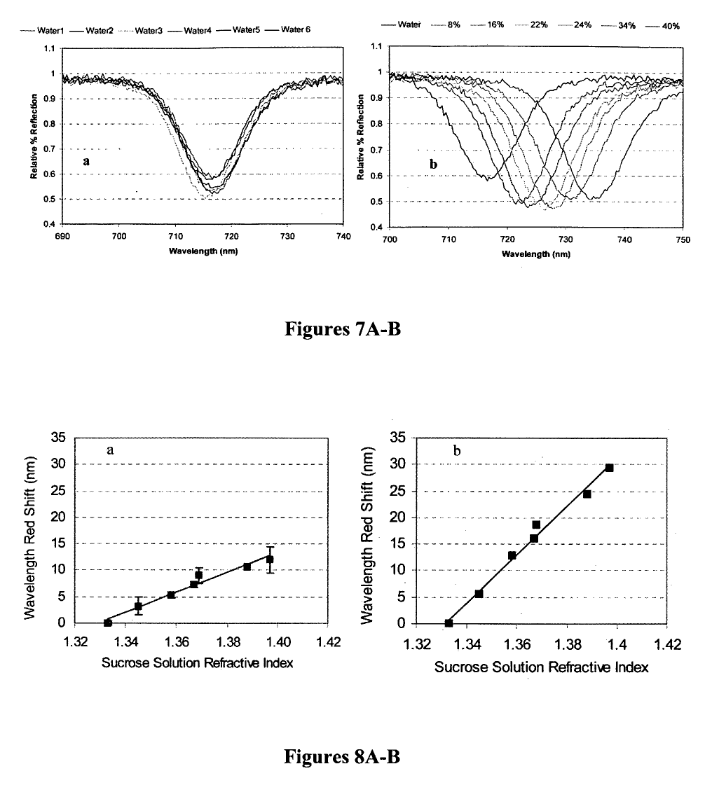

To be practically useful as a detection device, the dynamic range of the porous semiconductor material should be sufficient to respond to small changes in refractive index while embedded in the hydrogel. To test this, bulk sensitivity studies were conducted by exposing aqueous sucrose solutions of varying concentrations (see Table 1) to a gel-supported porous semiconductor material (3.7 μm thick; constructed with 9 periods per mirror of high porosity (85%) and low porosity (65%) layers and tuned with a resonance dip at ˜600 nm). FIG. 7 illustrates the optical response following contact lamination to a NU-GEL® sheet and subsequent exposure to water (FIG. 7A) and sucrose solutions FIG. 7B). The high resolution spectra clearly illustrate that the magnitude of the red shift is concentration dependent (FIG. 7B). Rinsing with copious amounts of water (5-10 ml) reproducibly returns the sensor to the baseline value FIG. 7A). This data demonstrates that the dynamic range of the porous semiconductor material is sufficiently sensitive to detect small changes (<0.01) in index of refraction while embedded in a hydrogel.

Table 1 provides a list of the sucrose solutions investigated. The refractive index was measured using an Abbe refractometer and the corresponding concentration was determined using a web-based tool (“A Momento on Sugar,” copyright. AvH Association, designed by Roberto Gilli).

TABLE 1
Sucrose Solutions Investigated

| | Measured | % Sugar |
|---|---|---|
| Solution # | Refractive Index | @ 589.3 nm |
| 1 | 1.333 | 0 |
| 2 | 1.345 | 8 |
| 3 | 1.358 | 16 |
| 4 | 1.367 | 22 |
| 5 | 1.369 | 24 |
| 6 | 1.388 | 34 |
| 7 | 1.397 | 40 |

To quantify these results further, the wavelength shift refractive index unit (RIU) sensitivity was determined by plotting the magnitude of the optical shift versus the refractive index (RI) of the sucrose solution, as shown in FIG. 8A. Several measurements were made at each concentration to determine standard error. The optical response is a linear function of RI and a RIU wavelength sensitivity of ˜190 nm/RIU is determined from the slope of a linear least squares fit. Measurements were also made using a ConMed Clearsite® gel-embedded porous semiconductor material, which yielded a similar RIU value (˜176 nm/RIU).

A control experiment was performed on a similar wafer-supported microcavity to assess the impact of the gel on the magnitude of the RIU wavelength sensitivity. These measurements were made employing the same sucrose solutions. Filling the pores with water yielded a 145 nm red shift, which is consistent with the shift observed following mounting in the hydrogel. Exposure to solutions of increasing sucrose concentration yielded a linear response curve shown in FIG. 8B; however, a much higher wavelength shift sensitivity of ˜454 nm/RIU was found. This value is consistent with values predicted from optical simulations (DeLouise & Miller, “Cross-Correlation of Optical Microcavity Biosensor Response With Immobilized Enzyme Activity—Insights in Structural Biology,” Anal. Chem. online, reference DOI 10.1021/ac048144+ (2005), which is hereby incorporated by reference in its entirety). Hence, the wafer-supported microcavity produces a ˜2.5 times larger wavelength shift per RI change than the gel-supported microcavity membrane.

The RIU sensitivity response for hydrogel-supported microcavity membrane was measured and contrasted to a wafer-supported control, which compared favorably to theoretical predictions. Results suggest that the RIU wavelength shift sensitivity is attenuated by mounting in the hydrogel by a factor ˜2.5. The dynamic range of the microcavity membrane remains, however, sufficiently sensitive to detect small changes in refractive index changes (Δ<0.01). Simulations suggest that sensitivity can be enhanced by operating at longer wavelengths in the near IR (DeLouise & Miller, “Cross-Correlation of Optical Microcavity Biosensor Response With Immobilized Enzyme Activity—Insights in Structural Biology,” Anal. Chem. online, reference DOI 10.1021/ac048144+ (2005), which is hereby incorporated by reference in its entirety). It is predicted that raising the % water composition will enhance sensitivity and infiltration through the porous semiconductor material.

### Example 4—Pathogen/Infection Detection

A porous silicon microcavity sensor is fabricated from and attached at the edges to single crystal silicon. While attached to the single crystal wafer, the microcavity is oxidized to make hydrophilic pore channels and create a protective coating, and surface chemical linkers (coupling agents) are added (see Hermanson, G. “Bioconjugate Techniques,” Academic Press (Jan. 8, 1996), U.S. patent application Ser. No. 10/082,634 to Chan et al., and U.S. Patent Application Ser. No. 60/661,674 to Ouyang et al., each of which is hereby incorporated by reference in its entirety). Biomolecular probes, chosen for their binding specifically to target pathogens likely to infect a wound and/or host markers of infection, are covalently immobilized onto the porous semiconductor material via the chemical linkers (see, for example, FIGS. 4A-B). The protective coating is useful to prevent premature degradation of the porous structure in contact with biological fluids. The silicon device is then imbedded into a hydrogel matrix. The hydrogel matrix can be preformed and the porous device transferred by contact lamination. The depth to which the silicon device resides within the gel matrix depends upon the lamination force used and the stiffness (density and degree of cross linking) of the gel. This composite structure is then placed on a wound. Exudate from the wound is wicked away by the adsorptive capacity of the hydrogel. This dynamic flow process draws exudate through the microcavity sensor creating the opportunity for target to bind to the probe. The high surface area of the 3D microstructure of the porous structure is advantageous for immobilizing a high concentration probe and thus creating a high detection sensitivity.

### Example 5—Drug Delivery

A porous multilayer or single layer structure is fabricated from and attached at the edges to single crystal silicon by methods discussed in Example 4. While attached to the single crystal wafer, the porous structure is loaded with biologically useful substances for time released drug delivery. Here the protective coating (i.e., oxidation to protect against biodegradation of the porous semiconductor material) is not applied. The unprotected porous semiconductor material containing biologically useful substances is then embedded in a preformed hydrogel matrix by contact lamination. This composite structure is then placed on the skin. The biologically useful substance is slowly delivered to the patient as the porous semiconductor material is spontaneously degraded by contact with biological fluids.

In Examples 4 and 5, immobilization of the probes and retention of the therapeutic agents, respectively, is carried out prior to the electropolishing step. However, as will be apparent to one of skill in the art, modifications to the porous semiconductor material (e.g., creation of hydrophilic pore channels, formation of protective coating, coupling of probes, and loading with therapeutic agents) may be carried out before or after electropolishing.

### Example 6—Fabrication Variations

SOI Wafers

Silicon on Insulator (SOI) wafers can be used as an alternative method to fabricate the free standing porous silicon single or multilayer device. The insulator layer (usually a silicon dioxide layer) substitutes for the electropolish release step. Possible advantages of this are better defined interface quality, which will be advantageous when it is desired to release the entire device from the wafer, avoiding the situation where the perimeter is anchored to the single crystal wafer. The porous silicon device is released by dissolving the oxide in HF, which does not spontaneously etch the porous silicon device.

Gel on Porous Device

Embodiments thus far described are fabricated by laminating a free standing film onto a preformed gel substrate. It is also possible to pour a pre-cross-linked gel fluid on top of the porous device. After a short time the gel cross links and the composite structure can be peeled away from the silicon wafer.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A product comprising:
a hydrogel matrix and
a porous semiconductor material at least partially embedded within the hydrogel matrix.

2. The product according to claim 1 wherein the hydrogel matrix is selected from the group of synthetic hydrogels, natural hydrogels, and mixtures thereof.

3. The product according to claim 2 wherein the hydrogel matrix is selected from the group of polyacrylamide hydrogels, polyvinyl hydrogels, polylactic acid hydrogels, polyglycolic acid hydrogels, polyethylene glycol hydrogels, agarose hydrogels, collagen hydrogels, acrylic hydrogels, acrylated quaternary ammonium monomeric hydrogels, polyurethane hydrogels, organic/inorganic hybrid hydrogels, cross-linked keratin hydrogels, and combinations thereof.

4. The product according to claim 1 wherein the hydrogel matrix comprises one or more agents selected from the group of antimicrobial agents, bacteriostatic agents, antiviral agents, and antifungal agents.

5. The product according to claim 1, wherein the porous semiconductor material comprises p-doped silicon, n-doped silicon, intrinsic or undoped silicon, a silicon alloy, a material based on Group III element nitrides, a material based on Group III.V materials, or combinations thereof.

6. The product according to claim 1, wherein the porous semiconductor material is substantially flexible.

7. The product according to claim 1 wherein the porous semiconductor material comprises:
a central layer interposed between upper and lower layers, each of the upper and lower layers including strata of alternating porosity; and
one or more probes coupled to the porous semiconductor material, the one or more probes being able to bind to a target molecule, whereby a detectable change occurs in a refractive index of the porous semiconductor material upon binding of the one or more probes to the target molecule.

8. The product according to claim 7, wherein the one or more probes are selected from the group of non-polymeric small molecules, polypeptides or proteins, antibodies, and oligonucleotides.

9. The product according to claim 7 wherein the one or more probes are the same.

10. The product according to claim 7 wherein each of the one or more probes is specific for one or more pathogens or one or more host markers of infection.

11. The product according to claim 7 wherein the porous semiconductor material comprises one or more therapeutic agents retained within one or more pores of the semiconductor material.

12. The product according to claim 1 wherein the porous semiconductor material comprises one or more therapeutic agents retained within one or more pores of the semiconductor material.

13. The product according to claim 12 wherein the one or more therapeutic agents is selected from the group of growth factors, keratins, cytokines, antibiotic agents, antimicrobial agents, antifungal agents, antiviral agents, and tumor suppressor agents.

14. The product according to claim 13 wherein the growth factors comprise basic fibroblast growth factor (bFGF), acidic fibroblast growth factor (aFGF), vascular endothelial cell growth factor (VEGF), platelet derived growth factor (PDGF), insulin-like growth factors (IGF-I and IGF-II), nerve growth factor (NGF), epidermal growth factor (EGF), heparin-binding EGF-like growth factor (HBEGF), transforming growth factor (TGF), or combinations thereof.

15. The product according to claim 13 wherein the keratins comprise type K1, type K5, type K10, type K14, or combinations thereof.

16. The product according to claim 13 wherein the cytokines comprise IL-1β, IL-1RA, TNF-α, IL-12, INF-γ, or combinations thereof.

17. The product according to claim 1 wherein the porous semiconductor material is fully embedded within the hydrogel matrix.

18. The product according to claim 1 further comprising
a vapor barrier applied to at least one side of the hydrogel matrix.

19. The product according to claim 1 further comprising:
a release layer contacting at least one side of the product.

20. A sterile package containing a sterile product according to claim 1.

21. A method of making a substantially flexible porous semiconductor material comprising:
introducing a semiconductor substrate into an electrochemical etching bath;
applying a current density for a sufficient duration to achieve a porous region of the semiconductor substrate; and
second applying a sufficiently high current density to cause electropolishing of an interface between the porous region and a remainder of the semiconductor substrate, wherein said second applying releases the porous region from the remainder of the semiconductor substrate.

22. The method according to claim 21 further comprising creating one or more hydrophilic pore channels in the porous semiconductor material.

23. The method according to claim 22 wherein said creating one or more hydrophilic pore channels comprises one or more thermal oxidation steps.

24. The method according to claim 22 wherein said creating one or more hydrophilic pore channels comprises immersing the porous semiconductor material in a solution comprising ethanol and hydrogen peroxide.

25. The method according to claim 21 further comprising lowering the surface tension of the porous semiconductor material.

26. A method of making the product of claim 1 comprising:
providing a porous semiconductor material; and
at least partially embedding the porous semiconductor material in a hydrogel matrix.

27. The method according to claim 26 wherein said at least partially embedding comprises fully embedding the porous semiconductor material in a hydrogel matrix.

28. The method according to claim 26 wherein said at least partially embedding comprises:
providing a hydrogel matrix, and
laminating the porous semiconductor material onto the hydrogel matrix under conditions effective to at least partially embed the porous semiconductor material in the hydrogel matrix.

29. The method according to claim 26 wherein said at least partially embedding comprises:
providing an activated monomer solution,
pouring the activated monomer solution over the porous semiconductor material, and
subjecting the activated monomer solution to one or more cross-linking steps under conditions effective to produce a hydrogel matrix, whereby the porous semiconductor material is at least partially embedded in the hydrogel matrix.

30. The method according to claim 26, further comprising:
coupling one or more probes to the porous semiconductor material prior to said at least partially embedding.

31. The method according to claim 26, further comprising:
loading one or more therapeutic agents into one or more pores of the semiconductor material prior to said at least partially embedding.

32. A method of detecting a pathogen and/or infection at a wound site, said method comprising:
providing a product of claim 10;
applying the product to a wound site; and
observing a detectable change in a refractive index of the porous semiconductor material, wherein a detectable change in the refractive index indicates presence of a pathogen and/or infection at the wound site.

33. A method of delivering one or more therapeutic agents to a subject, said method comprising providing a product according to claim 12 and applying the product to a tissue of the subject whereby the one or more therapeutic agents is delivered to the subject.
